(19) United States
(12) Patent Application Publication
(10) Pub. No.: US 2017/0352167 A1
(43) Pub. Date: Dec. 7, 2017

(54) SYSTEM AND METHOD FOR LAYERED VISUALIZATION OF EVALUATION RESULTS

(71) Applicant: General Electric Company, Schenectady, NY (US)

(72) Inventors: Adam RASHEED, Niskayuna, NY (US); Jonathan ARNOWITZ, San Francisco, CA (US)

(21) Appl. No.: 15/250,193

(22) Filed: Aug. 29, 2016

Related U.S. Application Data
(60) Provisional application No. 62/344,545, filed on Jun. 2, 2016.
(60) Provisional application No. 62/344,581, filed on Jun. 2, 2016.

(51) Int. Cl. G06T 11/20; G06F 17/24; G06F 3/14; G06F 3/0482; E21B 43/12; G06N 5/04; E21B 41/00

(52) U.S. Cl. CPC G06T 11/206; G06N 5/046; G06F 17/245; E21B 41/0092; G06F 3/0482; E21B 43/121; G06F 3/14

(57) ABSTRACT

A layered visualization element system includes a processor coupled to a bus, a display device, and a data store including artificial lift evaluation results and executable computer-readable instructions, the processor configured to access the artificial lift evaluation results and to create on the display a multi-layered graphical representation having a first layer depicting in a matrix format of cells an overview of the evaluation results, at least a portion of cells graphically representing results of an evaluation of an artificial lift type to one or more rules, a second layer depicting one or more details of the evaluation associated with the one or more results graphically represented in a user-selected cell element, and a third layer providing textual details of a feasibility score representing an analysis based on the evaluation results. A non-transitory computer-readable medium and a method for displaying artificial lift evaluations are disclosed.

### CLAIM OF PRIORITY

This patent application claims the benefit of priority, under 35 U.S.C. §119, to U.S. Provisional Patent Application Ser. No. 62/344,545, filed Jun. 2, 2016 titled “ARTIFICIAL LIFT SELECTION LAYERED VISUALIZATION ELEMENT,” and to U.S. Provisional Patent Application Ser. No. 62/344,581, filed Jun. 2, 2016 titled “METHOD FOR EVALUATING ARTIFICIAL LIFT FOR OIL WELLS.” The entire disclosures of both Provisional Application No. 62/344,545 and Provisional Application No. 62/344,581 are incorporated herein by reference.

### BACKGROUND

This decision of determining the most suitable type of artificial lift to install in an oil/gas well can be a complex process involving many factors ranging from technical feasibility, operating costs, maintenance practices, reliability, target productions, engineering design, company preferences and other factors. These decisions are often made with limited analysis, often relying on individual knowledge and experience, leading to less than optimal solutions that can be based on an individual's bias and/or experience with lift types. As a result, a conventional lift type selection process incorporates a limited view of what is the most suitable overall solution. Often, the conventional process(es) do not include technical and lifecycle economic analysis for a wide spectrum of artificial lift types.

Determining the best type of artificial lift system to install in the well is a complex process involving many factors ranging from technical feasibility, operating costs, maintenance practices, reliability, target productions, engineering design, historical preferences, and expert hunches.

Conventional lift selector tools have gained limited industry acceptance. This lack of acceptance can be due to two reasons: a lack of sufficient validation across many wells, and a lack of an easy-to-use interface. Determining the best type of artificial lift system to install in the well is a complex process involving many factors ranging from technical feasibility, operating costs, maintenance practices, reliability, target productions, engineering design, historical preferences, and expert hunches.

There is a need for an expert-system based artificial lift selector tool that includes an ease-of-use output visualization having an intuitive and layered output visualization to present evaluation results in a manner for a user to quickly understand the best recommendation and its criteria.

### BRIEF DESCRIPTION OF THE DRAWINGS

FIG. 1 depicts an artificial lift evaluator system that includes a layered visualization element in accordance with embodiments;

FIG. 2 depicts a dynamic graphic user interface that includes a graphical representation of a layered visualization element in accordance with embodiments; and

FIG. 3 depicts a magnified view of the graphical representation of a layered visualization element of FIG. 2 in accordance with embodiment.

### DETAILED DESCRIPTION

Embodying devices and methods provide a layered visualization output element that presents artificial lift evaluation results. In some implementations there can be three layers, but embodiments are not so limited and other numbers of layers is within the scope of this disclosure. Embodying layered visualization output elements provides a user with a first layer of information that indicate (at a high-level) the feasibility score of each artificial lift type; a second layer that presents reasons on considerations determining the feasibility score of each lift type by category; and a third layer that indicates specific results to evaluation rules triggered by the combination of the artificial lift type and the particular well undergoing evaluation.

In accordance with embodiments, rules are applied in category groups that are commonly considered when selecting among lift types. However, the subcategories could represent whichever level of detail is of interest to the user.

These embodying visualization layers present the complex options and/or recommendations technical assessment from an artificial lift evaluation algorithm in an intuitive and layered manner. Presenting these technical assessments in this manner provides a user with better access to a well's options and/or recommendations so that a more informed decision can be made then the presentation provided by prior artificial lift selector tools. Embodying layered visualization elements provide a user with more than the prior art “black box” recommendation of a single artificial lift type. Rather, an embodying layered visualization output provides a user with better access to the recommendations. This layered visualization output provides a user with guidance and transparency into the evaluation result rationale, with the final decision being left to the user.

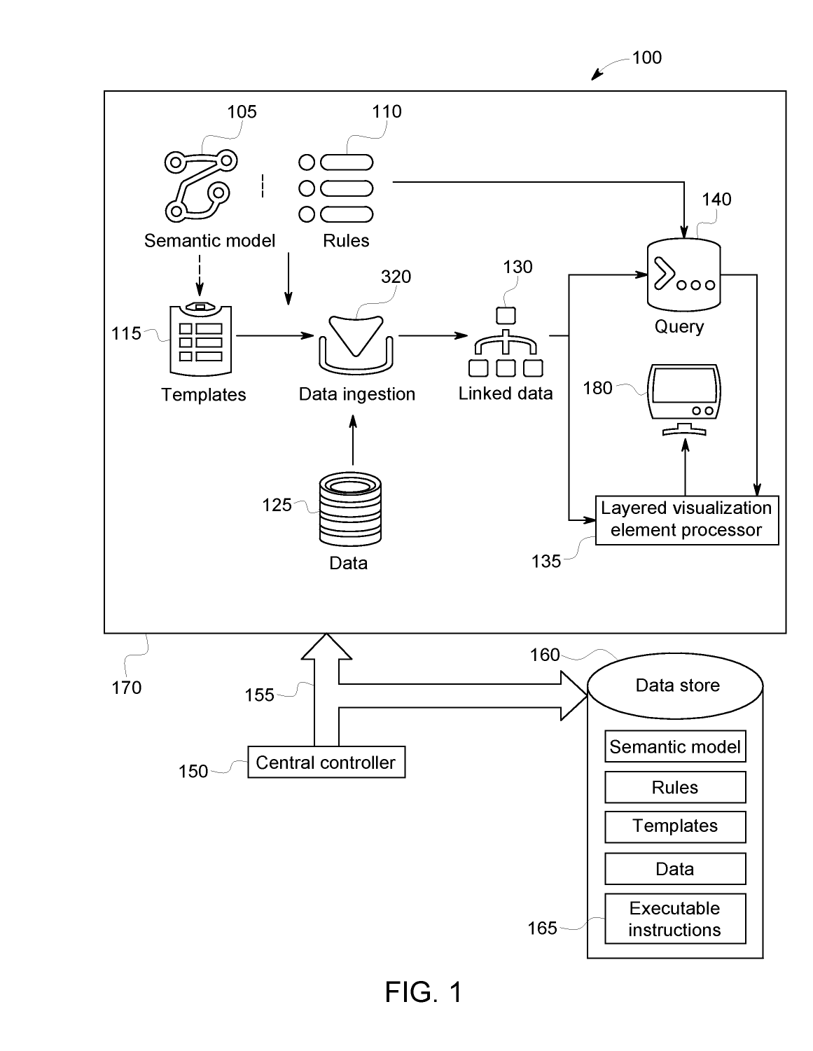

FIG. 1 depicts artificial lift evaluator system 100 including an embodying layered visualization element processor 135, and evaluation data flow (depicted in a semantic model for purposes of discussion). In FIG. 1, dashed lines indicate referencing concepts defined in the model, whereas, solid-lines represent actual use for inference. System 100 includes lift evaluator model 170, central controller 150, data store 160, and communication/data bus 155. In the lift evaluator model, an embodying semantic model 105 can capture the subject matter expert knowledge, concepts, and paradigms. Rules 110 (contained in a data store) allow inference of additional knowledge from the model. Templates 115 guide data ingestion 120 (e.g., mapping) of input data 125 to the subject matter expert (SME) knowledge, concepts, and paradigms in semantic model 110 resulting in linked data 130. The linked data retains connections between different pieces of information and can be viewed graphically and/or tabular in layered visualization element processor 135. Queries 140 allow extracting relevant data from the model, and any rules that need to be applied on the ingested data for decision making are applied at the time of query execution.

Central controller 150 may be a processing unit, a field programmable gate array, discrete analog circuitry, digital circuitry, an application specific integrated circuit, a digital signal processor, a reduced instruction set computer processor, etc. The central controller can include internal memory (e.g., volatile and/or non-volatile memory devices). The central controller may access a computer application program stored in non-volatile internal memory, or stored in an external memory that can be connected to the central controller via an input/output (I/O) port. The computer program application may include code or executable instructions 365 that when executed may instruct or cause the central controller and other components to perform embodying methods

Central controller 150 can control artificial lift evaluator system 100 including layered visualization element processor 135 via communication/data bus 155. Coupled to communication bus 155 is data store 160. Data store 160 can contain the semantic model, rules, templates, evaluation results, and computer executable instructions.

In some embodiments, data store 160 is implemented in Random Access Memory (e.g., cache memory for storing recently-used data) and one or more fixed disks (e.g., persistent memory for storing the full database). Alternatively, data store 160 may implement an “in-memory” database, in which volatile (e.g., non-disk-based) memory (e.g., Random Access Memory) is used both for cache memory and for storing the full database.

In accordance with embodiments, results of the artificial lift evaluation can be presented by layered visualization element processor 135 on graphics display device 180. The evaluation results can include a determination of different lift types being allowed or not allowed for a given well; any needed warning(s) for the allowed artificial lifts; and for artificial lifts that are allowed, a display of one or more scores that are assigned based on the number and severity of each of the warnings. These decisions can be based on analyzing one or more of three different types of rules—disallow rules, warning rules, and depth vs. volume rules.

In accordance with embodiments, the lift evaluator output can have three different categories of results: Disallowed, Warnings, and String Notes (a string format result for allowed lift types providing descriptions of further considerations for the operator). The disallowed, warnings, and string note outputs can be provided in a three column format. In an embodiment, the following columns can be included in the output: Lift Name (indicating the name of the lift with this output result); Rule Name (the rule that generated the output), and Reason (description of why this warning or disallow is issued for this lift). Other output format and presentation schemes are within the contemplation of this disclosure.

Based on the rule results from the semantic model, the score of each artificial lift is calculated. The score can be quantified as a relative metric. For purposes of this discussion, that relative metric is expressed as a percent fitness. Any artificial lifts that are disallowed are automatically assigned a disallowance score. For the lifts that are not disallowed, the initial score of 100% percent can be assigned. Then a predetermined amount is subtracted from the 100% depending on which warning(s) is issued for that lift, and the penalty associated with that warning. If the score of a lift goes below 0, then it is assigned a 0% fit.

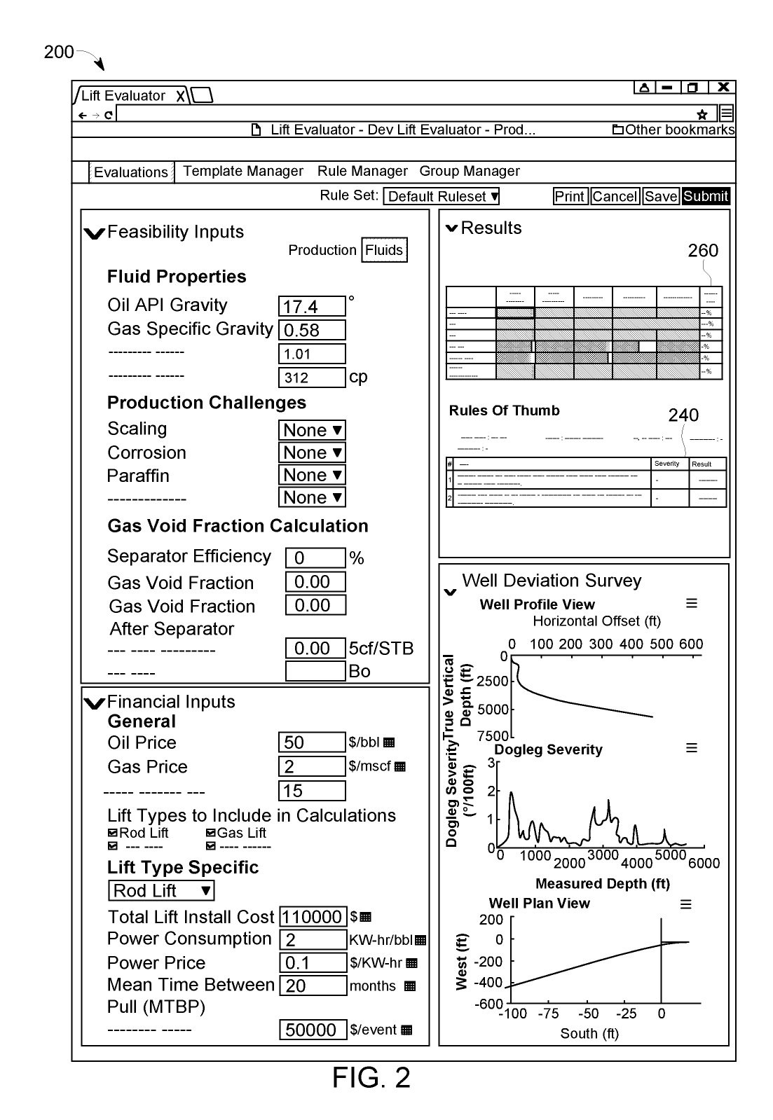

FIG. 2 depicts dynamic graphic user interface 200 that includes layered visualization element graphical representation 260 in accordance with embodiments. Layered visualization element 260 displays comparison results of the artificial lift types with dynamic elements in a multi-layered functionality that aids in the rapid comprehension of these results to lead to a technical assessment by the user.

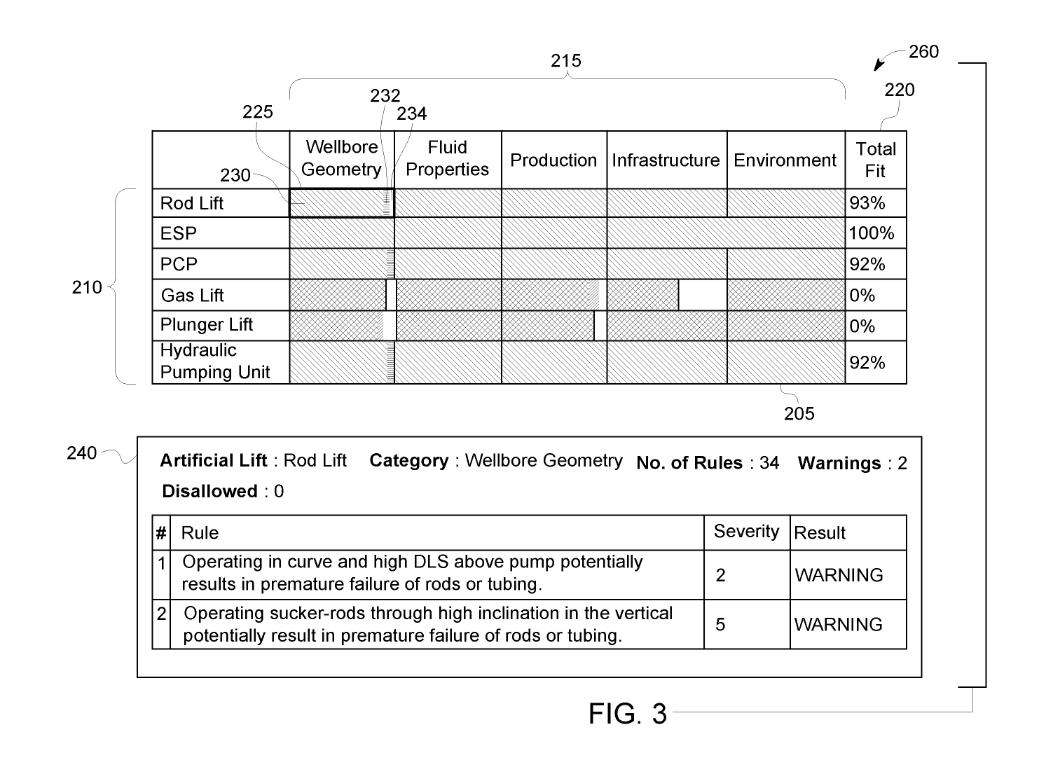

FIG. 3 depicts a magnified view of layered visualization element 260 in accordance with embodiments. An embodying layered visualization element presents results in multiple layers. In accordance with embodiments, as depicted in FIGS. 2-3 results can be depicted in results matrix 205. Rows 210 represent the artificial lift types under consideration (e.g., rod lift, ESP, PCP, etc.). Columns 215 represent categories of well technical details (e.g., wellbore geometry, fluid properties, production, infrastructure, environment, etc.). The categories of well technical details helps to differentiate among the lift types being considered. Each rule of the rules engine fits into one of the well technical detail categories. Score column 220 presents a feasibility score for each artificial lift type. By way of example, the score is displayed as a percentage of total fit. However, other rankings, representations, relative portrayals, and/or quantifications of the score is within the scope of this disclosure.

For purposes of this discussion, results matrix 205 is depicted as a rectangular table with shading in the cells. It should be readily understood that other depictions imparting the same comparison results in a layered visualization element (i.e., any shape, color scheme, and/or implementation) are within the scope of this disclosure.

Each cell of results matrix 205 visually depicts a first level of the comparison result by using row shading and/or coloring. A second level representing subcategories of the comparison is shown within the cell itself. A third level of the comparison for a highlighted cell of results matrix 205 can be shown in detailed text box 240.

As an example, results matrix 205 indicates that artificial lift type ESP received a total fit score of 100%. In each of the five well technical detail category columns, the cells of the ESP row are completely filled with the same crosshatching (or, in other implementations, shading, coloring). By comparison, artificial lift type Rod Lift received a total fit score of 93%. In four of the five well technical detail category columns, the Rod Lift cells are completely filled with the same crosshatching (or shading, coloring). However, Rod Lift cell 225 is not uniformly filled. Rod lift cell 225 has three distinct fills—fill_1 230, fill_2 232, and fill_3 234. From a quick visual inspection of results matrix 205 a user can discern based on the fill uniformity of each cell in the results matrix which artificial lift types are best suitable for a particular technical detail category of the well. In this manner, an embodying layered visualization element provides a quick identification as to which are the best, or worst, lift types for the well. For example, in the depicted illustration, a user can discern that the diagonal fill indicates the better lift types, and the solid grey indicates the worst lift types. Thus, a user can quickly identify their options in selecting a lift type for that well.

For example, with regard to highlighted Rod Lift cell 225, within the wellbore geometry category there are two warnings (fill_2 232 and fill_3 234). The remaining rules for the wellbore geometry category were not violated by the Rod Lift artificial type lift (as indicated by the 100% ranking represented by diagonal fill_1 230).

In accordance with embodiments, the crosshatching (or shading, coloring) scheme can be selected to represent predetermined thresholds of rule results. For example, a fit of about greater than 80% can result in a diagonal hatching for that rule; a fit of about 20-80% can result in a horizontal crosshatching; and a fit of about less than 20% can result in a grey fill (denoting a disallow status) for that rule. In accordance with implementations, any disallow status can result in a 0% total fit rating for that artificial lift type for that well.

In accordance with embodiments, hovering a pointing device (e.g., mouse, touch screen pen, tablet stylus, user finger, cursor, etc.) over a cell can induce the display of a dynamic text and/or graphic element. This dynamic graphic element can display more information of relevance regarding the content of the data and results associated with that cell—e.g., configuration details regarding that well technical details, the lift type parameters, financial data (well production, operating costs), etc.

Embodying systems and methods of layered visualization element 260 provide the user with an interactive display of data from which the user can readily and rapidly determine rankings of available options along with the reasoning of the rankings. In accordance with embodiments, other visual presentation cues can be used in the layered visualization element. For example, the intensity of a cell's fill color could equate to the score ranking (lighter being less, darker being more). The visual presentation cues are selected so that a user can quickly identify problem areas for each lift type, and help to identify which sub-category is the problem area.

In accordance with some implementations, a shading scheme can be used as the visual presentation cues—darkest representing rules that passed; less dark representing rules that passed with minor penalty points; lighter representing rules that passed with a moderate penalty; lightest shading representing rules that passed with severe penalty; and white representing rules that failed resulting in a disallowance of that lift type. With such visual presentation cues, a user can rapidly scan for light/white cell fill(s) to quickly identify problem categories. Each cell can have multiple visual presentation cues representing results for respective rules.

In accordance with some implementations, instead of a shading scheme representing the counts of the number of rules passed with different levels of severity, the shading can be related to the percent score within the sub-category. Instead of multiple shades per cell, in accordance with this implementation there can be one shade. If a subcategory has a total of ten possible points, and the rules for the subcategory achieved nine points, the cell would have a dark shade. If only one point is achieved, the cell would have the light shade. Any table cell shading scheme (or visual representation cue) can be adopted and tied to quantifiable data.

With reference to FIG. 3, the selection of a cell can result in that cell being highlighted (e.g., color shift, border enhancement, or other visual cue) indicating its selection. The selection of a cell results in the display of text box 240 that provides a display of the analysis associated with the results of the selected cell.

For purposes of discussion, the depicted text box 240 is associated with Rod Lift/wellbore geometry cell 225. The text box can dynamically update as additional analysis results are provided. The detailed analysis displayed in text box 240 provides details into why that particular category and lift type received the assigned score. Within the text box are shown the specific rules that received less than full score. Allows user to dive deep into the underlying technical assessment.

Once user identifies which row and sub-category is of interest, the user can select the cell to provide more details explaining why the sub-category is the problem. In accordance with embodiments, selecting a cell can update a table presented below the layered visualization element that provides (per row) every rule that was triggered and the amount of penalty points that were deducted for that rule. This allows the user to drill-down to the deepest level of the tool to understand why a subcategory (consequently a lift type) received the score it did. The user may agree or disagree with the detailed rules being triggered—so the purpose is for the user to have visibility into the underlying logic.

Additionally, selecting a cell can update metadata for that subcategory which is also dynamically updated above the detailed table (for example, artificial lift type, the category, the number of rules in that category, the number of warning rules triggered, and number of disallow rules triggered).

Although for purposes of discussion layered visualization element 260 is depicted in a rectangular table format, other formats and presentation schemes are within the contemplation of this disclosure. For example, the layered visualization element can be a pie-chart, a stacked-chart, a histogram, a bubble chart, or any other kind of representation. In accordance with some embodiments, the layered visualization element can be implemented as a hover box (a/k/a hover card), where a popup window can appear when a pointing device hovers over an icon.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for providing a layered visualization of evaluation results of disparate artificial lift types, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A layered visualization element system comprising:
a layered visualization element processor coupled to a communication/data bus and a graphics display device;
a data store coupled to the communication/data bus, the data store including artificial lift evaluation results and non-transitory executable computer-readable instructions;
the layered visualization element processor configured to access the artificial lift evaluation results and to create a multi-layered graphical representation of the evaluation results on the graphics display device;
the multi-layered graphical representation including a first layer depicting an overview of the evaluation results in a matrix format having a plurality of cell elements;
at least a portion of the plurality of cell elements graphically representing one or more results of an evaluation of an artificial lift type to one or more rules;
the layered visualization element processor configured to receive a cell selection from a pointer device;
the layered visualization element processor configured to present a second layer depicting one or more details of the evaluation associated with the one or more results graphically represented in the selected cell element; and
the layered visualization element processor configured to present a third layer providing textual details of a feasibility score, the feasibility score representing an analysis based on the results of the evaluation.

2. The layered visualization element system of claim 1, including the layered visualization element processor configured to access the executable computer-readable instructions, the executable computer-readable instructions causing the layered visualization element processor to perform the operations of:
updating the textual details as additional analysis results are provided; and
providing on the graphic display device a listing of each rule applied during the evaluation for the selected cell;

3. The layered visualization element system of claim 2, the executable computer-readable instructions causing the layered visualization element processor to perform the operations of:
updating metadata associated for at least one of a plurality of categories containing one or more of the applied rule for the selected cell; and
the metadata including a number representing a quantity of rules in the at least one of the plurality of categories, a number representing a quantity of rules applied by the evaluation to obtain data for the selected cell, and a number representing a quantity of warning rules triggered by the evaluation.

4. The layered visualization element system of claim 1, the executable computer-readable instructions causing the layered visualization element processor to perform the operations of:
if present in the evaluation results for the selected cell, displaying a warning notice based on the evaluation results for the selected cell; and
if present in the evaluation results for the selected cell, displaying a disallow notice based on the evaluation results for the selected cell

5. The layered visualization element system of claim 1, the executable computer-readable instructions causing the layered visualization element processor to perform the operation of highlighting a border of the selected cell.

6. The layered visualization element system of claim 1, the executable computer-readable instructions causing the layered visualization element processor to perform the operations of:
accessing linked data in the data store, the linked data retaining connections between analysis results and information used by the evaluation; and
displaying the linked data on the graphic display device.

7. The layered visualization element system of claim 1, the executable computer-readable instructions causing the layered visualization element processor to perform the operation of displaying a string note result of the evaluation.

8. The layered visualization element system of claim 1, the executable computer-readable instructions causing the layered visualization element processor to perform, for the selected cell, the operation of displaying the one or more results with respective visual presentation cues that are distinct within the selected cell.

9. The layered visualization element system of claim 8, the executable computer-readable instructions causing the layered visualization element processor to select the visual presentation cues based on a predetermined performance analysis threshold for the artificial lift type and the one or more rules associated with the selected cell.

10. The layered visualization element system of claim 1, including a cell displaying the feasibility score.

11. A non-transitory computer readable medium containing computer-readable instructions stored therein for causing a layered visualization element processor to perform operations for displaying artificial lift type evaluation results, the operations comprising:
receiving artificial lift evaluation results;
creating a multi-layered graphical representation of the evaluation results on a graphics display device;
depicting, in a first layer of the multi-layered graphical representation, an overview of the evaluation results in a matrix format having a plurality of cell elements;
at least a portion of the plurality of cell elements graphically representing one or more results of an evaluation of an artificial lift type to a rule;
displaying in one of the plurality of cell elements a feasibility score of the artificial lift type based on the results of the evaluation;
receiving a cell selection from a pointer device;
presenting a second layer depicting one or more details of the evaluation associated with the one or more results graphically represented in the selected cell element; and
presenting a third layer providing textual details of a feasibility score, the feasibility score representing an analysis based on the results of the evaluation.

12. The computer-readable instructions of claim 11 including instructions to cause the layered visualization element processor to perform operations including:
updating the textual details as additional analysis results are provided; and
providing on the graphic display device a listing of each rule applied during the evaluation for the selected cell;

13. The computer-readable instructions of claim 12 including instructions to cause the layered visualization element processor to perform operations including:
updating metadata associated for at least one of a plurality of categories containing one or more of the applied rule for the selected cell; and
including in the metadata a number representing a quantity of rules in the at least one of the plurality of categories, a number representing a quantity of rules applied by the evaluation to obtain data for the selected cell, and a number representing a quantity of warning rules triggered by the evaluation.

14. The computer-readable instructions of claim 11 including instructions to cause the layered visualization element processor to perform operations including:
if present in the evaluation results for the selected cell, displaying a warning notice based on the evaluation results for the selected cell; and
if present in the evaluation results for the selected cell, displaying a disallow notice based on the evaluation results for the selected cell

15. The computer-readable instructions of claim 11 including instructions to cause the layered visualization element processor to perform an operation of highlighting a border of the selected cell.

16. The computer-readable instructions of claim 11 including instructions to cause the layered visualization element processor to perform operations including:
accessing linked data in the data store, the linked data retaining connections between analysis results and information used by the evaluation; and
displaying the linked data on the graphic display device.

17. The computer-readable instructions of claim 11 including instructions to cause the layered visualization element processor to perform an operation of displaying a string note result of the evaluation.

18. The computer-readable instructions of claim 11 including instructions to cause the layered visualization element processor to perform, for the selected cell, an operation of displaying the one or more results with respective visual presentation cues that are distinct within the selected cell.

19. The computer-readable instructions of claim 18 including instructions to cause the layered visualization element processor to perform an operation of selecting the visual presentation cues based on a predetermined performance analysis threshold for the artificial lift type and the one or more rules associated with the selected cell.

20. The computer-readable instructions of claim 11 including instructions to cause the layered visualization element processor to depict the feasibility score in one of the plurality of cells.
